(19) United States
(12) Patent Application Publication
(10) Pub. No.: US 2022/0184763 A1
(43) Pub. Date: Jun. 16, 2022

(54) FLUID SUPPLY NOZZLE INSERT

(71) Applicant: SI FLOW TECH CO., LTD, Busan (KR)

(72) Inventor: Yeong Seong SEO, Busan (KR)

(21) Appl. No.: 17/436,704

(22) PCT Filed: Apr. 28, 2020
(86) PCT No.: PCT/KR2020/005601

§ 371 Date: Sep. 7, 2021

(30) Foreign Application Priority Data
May 2, 2019 (KR) 10-2019-0051600

(51) Int. Cl. B23Q 11/10; B05B 1/02; B05B 1/34

(52) U.S. Cl. CPC B23Q 11/1076; B05B 1/341; B05B 1/02

(57) ABSTRACT

A fluid supply nozzle insert comprises a center shaft body insertedly installed in a tube and having a circular cross-sectional shape; multiple collision protrusions formed to be spirally arranged in the longitudinal direction on the outer circumferential surface of the center shaft body while being spaced apart from each other; a conical outlet shaft body integrally formed with and extending from the front end of the center shaft body and having a diameter gradually decreasing in the direction in which a fluid moves; a connection shaft body integrally formed with and extending from the rear end of the center shaft body and having a circular cross-sectional shape; an inlet shaft body integrally formed with and extending from the rear end of the connection shaft body and having a circular cross-sectional shape; and multiple guide blades spirally arranged on the outer circumferential surface of the inlet shaft body.

### TECHNICAL FIELD

The present invention relates to a fluid supply nozzle insert which is installed inside a tube having a flow channel formed therein and generates high pressure and microbubbles when a fluid is moved and discharged through the flow channel.

### BACKGROUND ART

In general, when a workpiece made of a metal or the like is machined into a desired shape by a machine tool such as a grinding machine or a drilling machine, a machining fluid is supplied to a contact portion between the workpiece and a blade in order to cool heat generated during machining or remove debris of the workpiece from the machining spot.

At this time, the cutting heat caused by high pressure and frictional resistance at the contact portion between the workpiece and the blade wears down the edge of the blade and lowers the strength of the blade, thereby reducing tool life of the blade. In addition, if the debris cut off from the workpiece are not sufficiently removed, they may stick to the edge of the blade during machining, which may degrade machining precision.

In this case, the machining fluid reduces the frictional resistance between the tool and the workpiece, removes the cutting heat, and also performs cleaning to remove the debris cut off from a surface of the workpiece. For this, the machining fluid must have a low coefficient of friction, a high boiling point, and good penetration into the contact portion between the blade and the workpiece.

Japanese Patent Application Laid-Open No. 11-254281 (published on Sep. 21, 1999) discloses a technique for providing a gas emitting means for emitting a gas in a machining apparatus in order to forcibly infiltrate a machining liquid into a contact portion between a blade and a workpiece.

However, in the prior art, the means for emitting the gas at a high speed and high pressure should be provided in the machining apparatus in addition to a means for spraying the machining liquid, thus increasing the cost and the size of the apparatus. In addition, in a grinding machine, the machining liquid cannot sufficiently reach a contact portion between a grindstone and the workpiece due to the air rotating together along the outer circumferential surface of the grindstone rotating at a high speed. Thus, there is a problem in that it is difficult to sufficiently cool the heat generated during the machining to a desired level because the machining liquid cannot sufficiently penetrate into the contact portion by simply spraying the air in the same direction as the rotation direction of the grindstone.

### Technical Problem

An object of the present invention is to provide a fluid supply nozzle insert capable of improving the characteristics of a fluid discharged to the place of use while increasing a pressure in the fluid flowing through a flow channel and generating bubbles.

### Technical Solution

The present invention provides a fluid supply nozzle insert which is insertedly installed in a tube having a flow channel through which a fluid moves, so as to discharge the fluid at a high pressure, the fluid supply nozzle insert comprising: a center shaft body insertedly installed in a tube and having a circular cross-sectional shape; multiple collision protrusions formed to be spirally arranged in the longitudinal direction on the outer circumferential surface of the center shaft body while being spaced apart from each other; a conical outlet shaft body integrally formed with and extending from the front end of the center shaft body and having a diameter gradually decreasing in the direction in which a fluid moves; a connection shaft body integrally formed with and extending from the rear end of the center shaft body and having a circular cross-sectional shape; an inlet shaft body integrally formed with and extending from the rear end of the connection shaft body and having a circular cross-sectional shape; and multiple guide blades spirally arranged on the outer circumferential surface of the inlet shaft body, wherein the connection shaft body is formed to have the same diameter as the inlet shaft body, and the center shaft body is formed to have a larger diameter than the inlet shaft body.

In addition, a tapered portion having a diameter gradually decreasing in a direction opposite to the direction in which the fluid moves may be formed on the outer circumferential surface of the rear end of the center shaft body connected to the front end of the connection shaft body, and a plurality of fluid inlet guide grooves may be formed to be spaced apart from each other in the circumferential direction on the outer circumferential surface of the center shaft body on which the tapered portion is formed.

In addition, a plurality of connection guide grooves may be formed in a spiral on the outer circumferential surface of the connection shaft body to be spaced apart from each other in the circumferential direction so as to be connected to the fluid inlet guide grooves.

In addition, a plurality of discharge guide grooves may be formed in a spiral on the outer circumferential surface of the outlet shaft body to be spaced apart from each other in the circumferential direction.

### Advantageous Effects

When a fluid is supplied to a tube, a fluid supply nozzle insert according to the present invention allows the fluid to flow into the space between a connection shaft body and the pipe while swirling along guide blades of an inlet shaft body, allows the fluid flowing into the space to move while swirling again while colliding with collision protrusions of a center shaft body again and thereby causing microbubbles to be generated, and allows the fluid to be discharged at an increased pressure to the outside of the pipe while containing the microbubbles after moving along the outer surface of a conical outlet shaft body to a discharge port of the pipe.

### BRIEF DESCRIPTION OF THE DRAWINGS

FIG. 1 is a perspective view of a fluid supply nozzle insert according to an embodiment of the present invention.

FIG. 2 is a front view of the fluid supply nozzle insert according to an embodiment of the present invention.

FIG. 3 is a cross-sectional view showing an installation state of the fluid supply nozzle insert according to an embodiment of the present invention.

FIG. 4 is a partial perspective view of an outlet shaft body shown in FIG. 1 according to another embodiment.

FIG. 5 is a partial perspective view of a connection shaft body shown in FIG. 1 according to another embodiment.

### DETAILED DESCRIPTION

Hereinafter, preferred embodiments of the present invention will be described in detail with reference to the accompanying drawings.

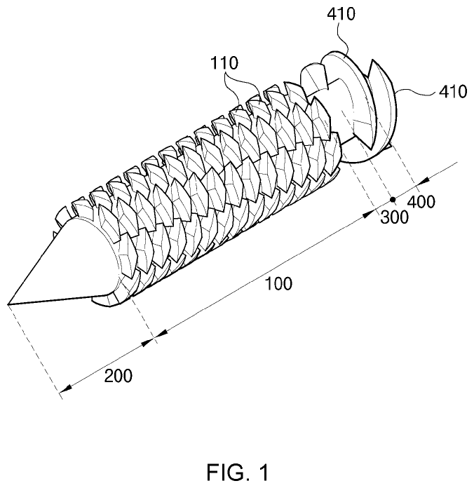

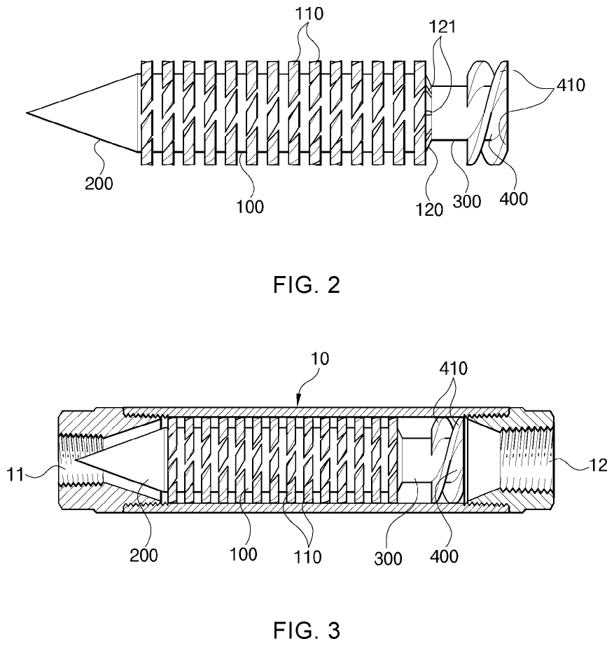

FIG. 1 is a perspective view of a fluid supply nozzle insert according to an embodiment of the present invention, FIG. 2 is a front view of the fluid supply nozzle insert according to an embodiment of the present invention, and FIG. 3 is a cross-sectional view showing an installation state of the fluid supply nozzle insert according to an embodiment of the present invention. Referring to FIGS. 1 to 3, the fluid supply nozzle insert according to an embodiment which is provided with a center shaft body 100, collision protrusions 110, an outlet shaft body 200, a connection shaft body 300, an inlet shaft body 400, and guide blades 410 is insertedly installed in a pipe 10 having a fluid channel through which a fluid moves and allows the fluid moving through the fluid channel of the pipe 10 to be discharged at high pressure. A discharge port 11 for discharging the fluid is formed at the front end of the tube 10, and an inlet port 12 is formed at the rear end of the tube 10. In this case, the discharge port 11 may be formed in a tapered structure in which the diameter gradually decreases toward the front end so that the discharged fluid can be sprayed at high pressure.

The center shaft body 100 is a portion to form countless microbubbles in the fluid moving through the pipe 10. The center shaft body 100 is a shaft member having a circular cross-sectional shape, and a plurality of collision protrusions 110 are formed on the outer circumferential surface of the center shaft body 100. In this case, the collision protrusions 100 preferably have a rhombus shape, but is not limited thereto. Additionally, the collision protrusions 110 are formed to be spaced apart from each other at regular intervals on the outer circumferential surface of the central shaft body 100, and more specifically, formed to be arranged spirally along the longitudinal direction of the central shaft body 100. In this way, the collision protrusions 110 cause the fluid moving through the tube 10 to collide with them and pass through a narrow flow channel while causing a flip-flop phenomenon and cavitation, so that vortices and microbubbles are generated in the fluid.

In addition, a tapered portion 120 having a diameter gradually decreasing in the direction opposite to the direction in which the fluid moves may be formed on the rear end of the center shaft body 100, that is, the outer circumferential surface of the rear end of the center shaft body 100 that is connected to the front end of the connection shaft body 300 which will be described below. Further, a plurality of fluid inlet guide grooves 121 may be formed to be spaced apart from each other in the circumferential direction on the outer circumferential surface of the rear end of the center shaft body 100 on which the tapered portion 120 is formed. The tapered portion 120 and the fluid inlet guide grooves 121 allow the fluid introduced into the fluid channel of the pipe 10 where the connection shaft body 300 is located to move to the center shaft body 100.

The outlet shaft body 200 is a portion that naturally guides the fluid passing through the center shaft body 100 to the discharge port 11 of the pipe 10 to allow the fluid to be discharged. The outlet shaft body 200 is a conical member, and is integrally formed with and extends in the longitudinal direction from the front end of the center shaft body 100. The rear end diameter of the outlet shaft body 200 is formed to be the same as the front end diameter of the center shaft body 100, so that the fluid passing through the center shaft body 100 naturally follows along the outer surface of the outlet shaft body 200. In this way, the outlet shaft body 200 widens the flow channel in the tube 10 through which the fluid passing through the center shaft body 100 flows, resulting in reduction of the pressure between the fluid and the outer circumferential surface of the outlet shaft body 200, causing the fluid to be pulled toward the outer circumferential surface of the outlet shaft body 200, thereby inducing a natural flow of the fluid along the outer circumferential surface of the outlet shaft body 200.

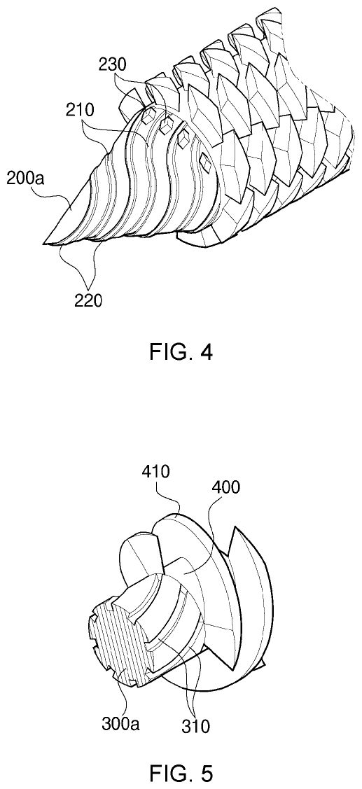

FIG. 4 is a partial perspective view of an outlet shaft body 200a according to another embodiment, and a plurality of discharge guide grooves 210 may be formed in a spiral on the outer circumferential surface of the outlet shaft body 200a to be spaced apart from each other in the circumferential direction. In addition, a plurality of discharge guide protrusions 220 may be formed on the outer circumferential surface of the outlet shaft body 200a to be formed in parallel between the discharge guide grooves 210. The discharge guide grooves 210 and the discharge guide protrusions 220 may increase the ejection force by the discharge port 11 while allowing the fluid moving along the outer surface of the outlet shaft body 200a to move in a vortex state.

Further, a plurality of collision discharge protrusions 230 may be formed to be spaced apart from each other in the circumferential direction on the outer circumferential surface of the rear end of the outlet shaft body 200a according to another embodiment. The collision discharge protrusions 230 may cause the fluid that is transferred to the outer circumferential surface of the rear end of the outlet shaft body 200a after passing through the center shaft body 100 to collide with them again to generate additional microbubbles, and may also induce the fluid to move to an adjacent state. The collision discharge protrusions 230 preferably have a rhombus shape.

The connection shaft body 300 is a portion that connects the center shaft body 100 and the inlet shaft body 400 which will be described below. The connection shaft body 300 is a shaft member having a circular cross-sectional shape with the same diameter as that of the center shaft body 100. Here, the connection shaft body 300 is integrally formed with and extends in the longitudinal direction from the rear end of the center shaft body 100. The connection shaft body 300 allows the fluid moving while swirling through the inlet shaft body 400 to pass through the center shaft body 100 after being located at the rear of the center shaft body 100. Accordingly, the connection shaft body 300 provides a space for storing the fluid between the center shaft body 100 and the inlet shaft body 400, so that when the fluid moves through the inlet shaft body 400, the occurrence of backflow is reduced at the rear of the inlet shaft body 400 and the fluid is allowed to be supplied between the collision protrusions 110 while maintaining the fluid at high pressure and maintaining a stable amount of fluid, thereby causing vortices and microbubbles to be generated in the fluid passing through the center shaft body 100.

In addition, FIG. 5 is a partial perspective view of a connection shaft body 300a according to another embodiment, in which a plurality of connection guide grooves 310 may be formed to be spaced apart from each other in the circumferential direction on the outer circumferential surface of the connection shaft body 300a. The connection guide grooves 310 are connected to the fluid inlet guide grooves 121 of the center shaft body 100 so as to guide the fluid that has passed through the inlet shaft body 400 to stably flow to the fluid inlet guide grooves 121 of the center shaft body 100. Here, the connection guide grooves 310 may be formed in a spiral so that the fluid that is introduced into the space between the connection shaft body 300a and the pipe 10 after passing through the inlet shaft body 400 can move to the center shaft body 100 while swirling.

The inlet shaft body 400 causes vortices to be generated in the fluid moving through the pipe 10, more specifically, in the fluid moving in the direction of the connection shaft body 300. The inlet shaft body 400 is a shaft member having a circular cross-sectional shape, and a plurality of guide blades 410 formed in a spiral to generate vortices in the flowing fluid are coupled to the outer circumferential surface of the inlet shaft body 400. Here, the inlet shaft body 400 is integrally formed with and extend in the longitudinal direction from the rear end of the connection shaft body 300.

In this way, when a fluid is supplied to the tube 10, the fluid supply nozzle insert of an embodiment allows the fluid to flow into the space between the connection shaft body 300 and the pipe 10 while swirling along the guide blades 410 of the inlet shaft body 400, allows the fluid flowing into the space to move while swirling while colliding with the collision protrusions 110 of the center shaft body 100 again and thereby causing microbubbles to be generated, and allows the fluid to be discharged at an increased pressure to the outside of the pipe 10 while containing the microbubbles after moving along the outer surface of the conical outlet shaft body 200 to the discharge port 11 of the pipe 10.

While the present invention has been particularly shown and described with reference to exemplary embodiments thereof, it will be understood by those of ordinary skill in the art that various changes in form and details may be made therein without departing from the spirit or scope of the invention as defined by the following claims.

What is claimed is:

1. A fluid supply nozzle insert which is insertedly installed in a tube having a flow channel through which a fluid moves, so as to discharge the fluid at a high pressure, the fluid supply nozzle insert comprising:
a center shaft body insertedly installed in a tube and having a circular cross-sectional shape;
multiple collision protrusions formed to be spirally arranged in the longitudinal direction on the outer circumferential surface of the center shaft body while being spaced apart from each other;
a conical outlet shaft body integrally formed with and extending from the front end of the center shaft body and having a diameter gradually decreasing in the direction in which a fluid moves; a connection shaft body integrally formed with and extending from the rear end of the center shaft body and having a circular cross-sectional shape;
an inlet shaft body integrally formed with and extending from the rear end of the connection shaft body and having a circular cross-sectional shape; and
multiple guide blades spirally arranged on the outer circumferential surface of the inlet shaft body,
wherein the connection shaft body is formed to have the same diameter as the inlet shaft body, and the center shaft body is formed to have a larger diameter than the inlet shaft body.

2. The fluid supply nozzle insert of claim 1, wherein a tapered portion having a diameter gradually decreasing in a direction opposite to a direction in which the fluid moves is formed on the outer circumferential surface of the rear end of the center shaft body connected to the front end of the connection shaft body and a plurality of fluid inlet guide grooves are formed to be spaced apart from each other in the circumferential direction on the outer circumferential surface of the center shaft body on which the tapered portion is formed.

3. The fluid supply nozzle insert of claim 2, wherein a plurality of connection guide grooves are formed in a spiral on the outer circumferential surface of the connection shaft body to be spaced apart from each other in the circumferential direction so as to be connected to the fluid inlet guide grooves.

4. The fluid supply nozzle insert of claim 1, wherein a plurality of discharge guide grooves are formed in a spiral on the outer circumferential surface of the outlet shaft body to be spaced apart from each other in the circumferential direction.
